(19) United States
(12) Patent Application Publication
(10) Pub. No.: US 2009/0064237 A1
(43) Pub. Date: Mar. 5, 2009

(54) USER-SELECTABLE VARIABLE-SIZED CHIP OVERLAY OF VIDEO BROADCAST

(75) Inventor: David E. Feldstein, Santa Monica, CA (US)

Correspondence Address: THE DIRECTV GROUP, INC.;PATENT DOCKET ADMINISTRATION, CA / LA1 / A109, 2230 E. IMPERIAL HIGHWAY, EL SEGUNDO, CA, 90245, US

(73) Assignee: THE DIRECTV GROUP, INC., El Segundo, CA (US)

(21) Appl. No.: 11/850,560

(22) Filed: Sep. 5, 2007

(51) Int. Cl. H04N 7/20

(52) U.S. Cl. 725/63

(57) ABSTRACT

The present invention comprises an interactive system and method for displaying a chip (or overlay video) on a video monitor. A system in accordance with the present invention comprises a first video stream presenting at least video information, the first video stream comprising a viewer channel, and an overlay video, displayed simultaneously with the first video stream, wherein the overlay video has a universal functionality with respect to at least one of a plurality of other video streams.

### BACKGROUND OF THE INVENTION

1. Field of the Invention

The present invention relates generally to satellite video systems, and in particular, to a method, apparatus, and article of manufacture for determining viewership of individual programs in a real-time environment.

2. Description of the Related Art

Satellite broadcasting of communications signals has become commonplace. Satellite distribution of commercial signals for use in television programming currently utilizes multiple feedhorns on a single Outdoor Unit (ODU) which supply signals to up to eight IRDs on separate cables from a multiswitch.

FIG. 1 illustrates a typical satellite television installation of the related art.

System 100 uses signals sent from Satellite A (SatA) 102, Satellite B (SatB) 104, and Satellite C (SatC) 106 that are directly broadcast to an Outdoor Unit (ODU) 108 that is typically attached to the outside of a house 110. ODU 108 receives these signals and sends the received signals to IRD 112, which decodes the signals and separates the signals into viewer channels, which are then passed to monitor 114 for viewing by a user. There can be more than one satellite transmitting from each orbital location and additional orbital locations without departing from the scope of the present invention.

Satellite uplink signals 116 are transmitted by one or more uplink facilities 118 to the satellites 102-106 that are typically in geosynchronous orbit. Satellites 102-106 amplify and rebroadcast the uplink signals 116, through transponders located on the satellite, as downlink signals 120. Depending on the satellite 102-106 antenna pattern, the downlink signals 120 are directed towards geographic areas for reception by the ODU 108.

Alternatively, uplink facilities 118 can send signals via cable 122 either in conjunction with uplink signals 116 or instead of uplink signals 116 to IRD 112, for display on monitor 114.

Each satellite 102-106 broadcasts downlink signals 120 in typically thirty-two (32) different frequencies, which are licensed to various users for broadcasting of programming, which can be audio, video, or data signals, or any combination. These signals are typically located in the Ku-band of frequencies, i.e., 11-18 GHz, or in the Ka-band of frequencies, i.e., 18-40 GHz, but typically 20-30 GHz.

As satellites 102-106 broadcast additional services and additional channels to viewers, viewers will like and expect to see programming on monitor 114 that relate to their specific needs and desires.

### SUMMARY OF THE INVENTION

To minimize the limitations in the prior art, and to minimize other limitations that will become apparent upon reading and understanding the present specification, the present invention discloses an interactive system and method for displaying a chip (or overlay video) on a video monitor.

A system in accordance with the present invention comprises a first video stream presenting at least video information, the first video stream comprising a viewer channel, and an overlay video, displayed simultaneously with the first video stream, wherein the overlay video has a universal functionality with respect to at least one of a plurality of other video streams.

Such a system further optionally comprises the overlay video displaying different analogous data elements with respect to each of the other video streams, the interactive system changing display of the overlay video from an identifying display of a first other video stream to an identifying display of a second other video stream, the overlay video comprising a menu screen, the menu screen comprising instructions to access additional overlay video screens, at least one of the additional overlay video screens comprising a plurality of data areas, at least one of the additional overlay video screens comprising a single data area that is scrolled through via the remote control, a nested video screen being accessed through the plurality of data areas, a nested video screen being accessed through the single data area, and the nested video screen being only accessible through the single data area.

Another system in accordance with the present invention displays a plurality of individual video feeds at a given time, and comprises a broadcast delivery system, comprising a transmitter and a receiver, a monitor, coupled to the receiver, for displaying a first video stream presenting at least video information, the first video stream comprising a viewer channel, and an overlay video, displayed simultaneously with the first video stream, wherein the overlay video has a universal functionality with respect to at least one of a plurality of other video streams.

Such a system further optionally comprises the broadcast delivery system being a satellite television delivery system, the overlay video displaying different analogous data elements with respect to each of the other video streams, a menu screen comprising instructions to access additional overlay video screens, at least one of the additional overlay video screens comprising a plurality of data areas, and the at least one overlay video screen being only accessible through the plurality of data areas.

Another system for displaying an overlay video and at least one other video feed at a given time in accordance with the present invention comprises means for transmitting the overlay video and the at least one other video feed, means for displaying a first video feed presenting at least video information, and means for displaying the overlay video simultaneously with the first video stream, wherein the overlay video has a universal functionality with respect to at least one of a plurality of other video streams.

Other features and advantages are inherent in the system disclosed or will become apparent to those skilled in the art from the following detailed description and its accompanying drawings.

### BRIEF DESCRIPTION OF THE DRAWINGS

Referring now to the drawings in which like reference numbers represent corresponding parts throughout:

FIG. 1 illustrates a typical satellite television installation of the related art;

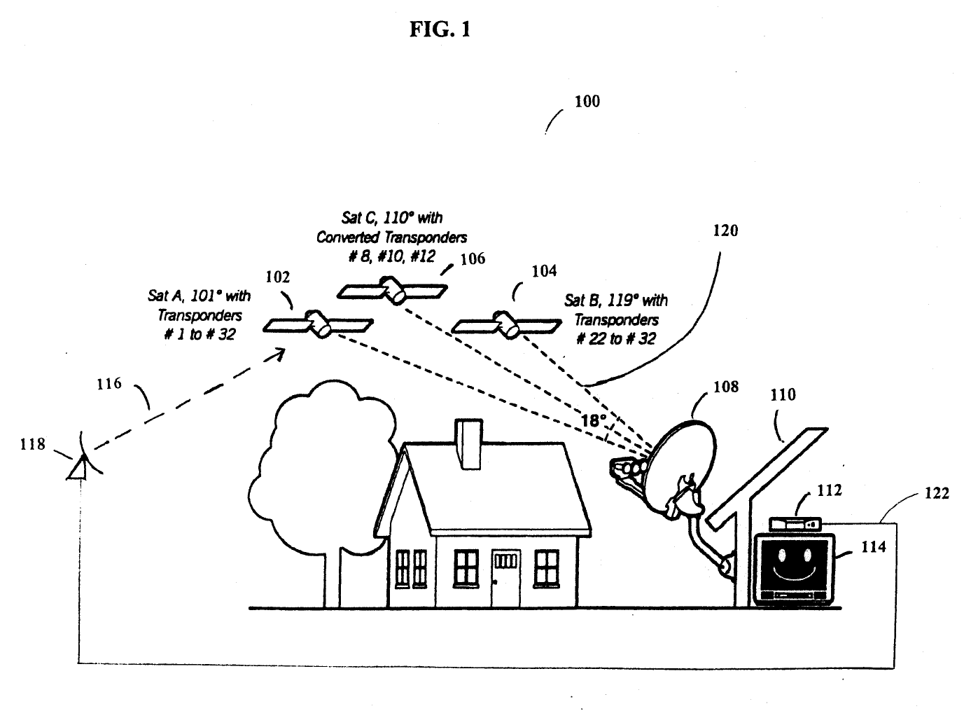

FIG. 2 illustrates a typical six-cell matrix with a generic video feed in accordance with the present invention;

FIG. 3 illustrates a remote control used in the present invention;

FIG. 4 illustrates a viewer channel shown on a monitor in accordance with the present invention;

FIG. 5 illustrates an informational overlay in accordance with the present invention;

FIG. 6 illustrates a menu associated with the informational overlay of FIG. 5;

FIG. 7 illustrates a score chip in accordance with the present invention;

FIG. 8 illustrates a single game score chip in accordance with the present invention; and

FIG. 9 illustrates a scoring summary chip in accordance with the present invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

The present invention is an interactive television channel that allows a viewer to view a video stream and select specific audio and/or video from the video stream based on a viewer's individual desires. The video stream is typically delivered to a user's monitor 114 via system 100, but could be done using cable or other terrestrial techniques.

When a viewer watches a specific program on a monitor 114, they are watching a “viewer channel” that comprises video and audio information that is routed to a specific “channel” to the monitor 114. For example, when a viewer wants to watch the local FOX affiliate station, they know that station is associated with a specific channel number on their monitor 114 or IRD 112, e.g., channel 11. When they program or otherwise indicate to the monitor 114 or IRD 112 to tune to channel 11, the monitor 114 or IRD 112 manipulates the electronics to capture and present the video information associated with that command from the satellite downlink 120, or from another source such as a coaxial cable input (cable TV) or terrestrial broadcast frequencies to present that information on monitor 114. The “viewer channel” information is typically the information that is presented when a viewer selects a given “channel” on the monitor 114 or IRD 112.

The present invention optionally provides additional viewer channels that comprise multiple video feeds that would normally be presented to a viewer on separate viewer channels, as well as optionally presenting indicators of what is happening on each video feed. A viewer channel that comprises multiple video feeds from other stand-alone channels is typically called a “mix channel.”

The present invention also allows a viewer to select various portions of the video and audio presentation based on commands sent by the viewer, typically via the remote control, to select the desired video and audio that is presented. This presentation is typically referred to as an “interactive channel,” an “interactive matrix channel,” or an “interactive mosaic channel” herein.

Within the interactive mosaic channel, the viewer is given several choices of other viewer channels to view, either simultaneously as in a matrix view, or the viewer can choose one of the matrixed viewer channels directly from the interactive mosaic channel.

Further, other presentations of the mix channel can be presented even after a user has selected one of the video feeds to view directly.

There can be more than one interactive channel as described above, and, as such each of the interactive channels can have a thematic core, genre, or subject. For example, the interactive channels can comprise a group of related channels, such as a group of viewer channels that provide news programming, a second group of viewer channels that provide sports programming, a group of channels that provide children's programming, a group of channels that provide home shopping programming, or a group of channels that is selected by the user. Other groupings can be presented, such as all of the local network affiliate channels, specialty groups such as a group of channels that provide foreign-language specific programming, pay-per-view preview channels, sports programming, etc. The present invention is not limited based on the grouping of channels matrixed together to comprise the interactive mosaic channel.

The interactive mosaic channel can be reached in a similar fashion to the other viewer channels available for viewing on monitor 114; the interactive mosaic channel can be selected from the programming guide, the interactive mosaic channel number can be entered directly on the remote control, or the interactive mosaic channel would be found when the user is “channel surfing” or using the “next higher or lower channel” button on the remote control or directly on the monitor 114 or IRD 112.

### Interactive Mosaic Channel Display Diagram

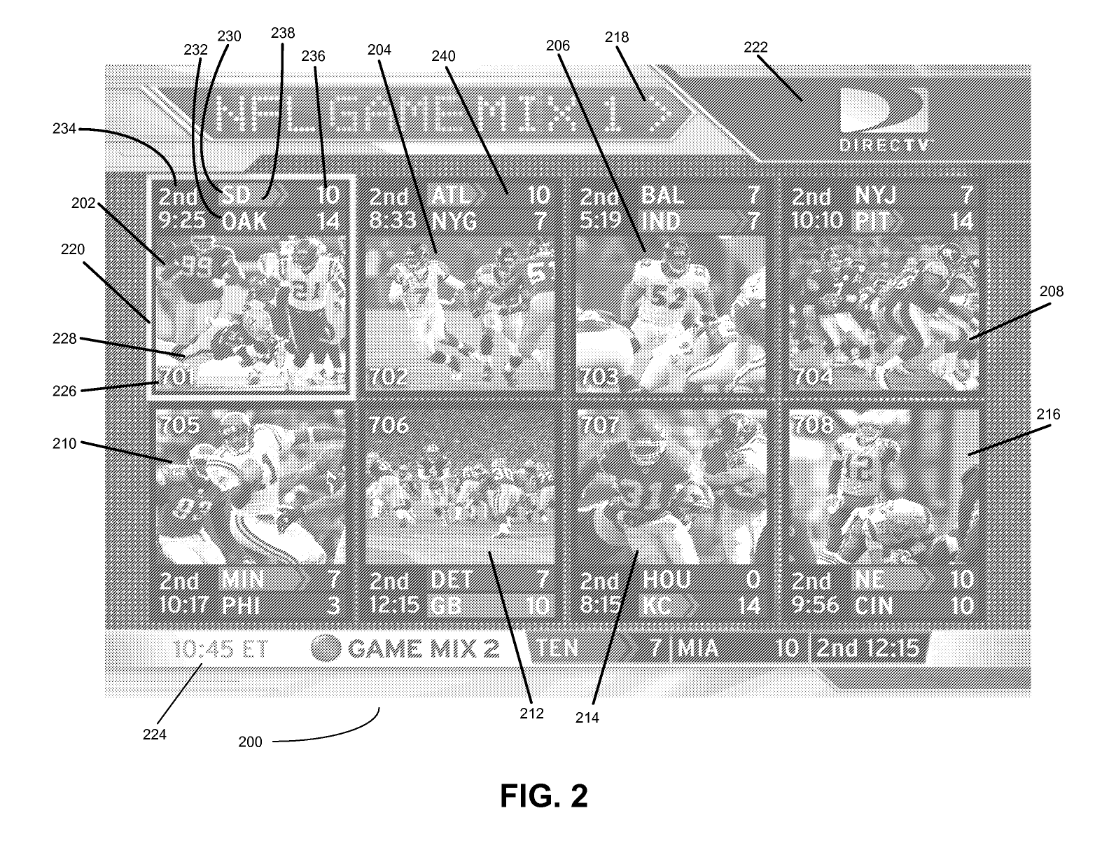

FIG. 2A illustrates a typical eight-cell matrix with a generic video feed in accordance with the present invention.

Interactive mosaic channel 200 is shown as being displayed on monitor 114. Within interactive mosaic channel 200, there are a number of video cells 202-216 and a text box 218, also referred to as an On Screen Display (OSD) 218. Optionally, the interactive mosaic channel 200 further comprises a cursor 220, a background video graphic 222, and a dynamic ticker 224.

The number of video cells 202-216 can change based on the number of video cells 202-216 desired. As the number of video cells 202-216 increases, of course, there must be a reduction in the size of the video cells 202-216 to ensure that the video cells 202-216 can be differentiated on the monitor 114. As the number of video cells 202-216 decreases, the size of the video cells 202-216 can increase, since there is more space available on monitor 114 to display video cells 202-216.

Further, the placement of video cells 202-216, text box 218, background graphic 222, and ticker 224 is not limited to the positions on monitor 114 as shown in FIG. 2A. These elements 202-216, 218, 222, and 224 can be displayed anywhere on monitor 114 without departing from the scope of the present invention.

As there are multiple video feeds, e.g., one video feed for each video cell 202-216 being presented, each video cell 202-216, as well as text box 218, background video 222 and possibly dynamic ticker 224, have associated audio portions that can be played. Presenting more than one audio stream may be confusing to a viewer of monitor 114; as such, it is typical that only one audio stream of information is presented at a given time. Further, each of the video feeds may also have closed-captioning information associated with it, and selection of a closed-captioned presentation, rather than an audio presentation, can be performed if desired.

### Video Cells

Video cells 202-216 each typically contain a separate viewer channel of programming. Further, each video cell 202-216 contains other information that is presented within the video cell as described herein.

Channel indicator 226 is shown within video cell 202, to show the viewer the “direct tune” channel number for that video cell 202. For example, video cell 202 shown in FIG. 2 shows a channel indicator 226 displaying channel 701 as the channel for that video information. When cursor 220 is placed on (or around) that video cell 202, as is shown in FIG. 2, the audio or other associated data for that video cell 202 can be presented to the viewer.

### Related Data

There also may be other related data for a given video cell 202-216 that is of interest to a viewer. For example, as shown in video cell 202, the video feed 228 content is a National Football League™ game. Team identifiers 230-232 indicate that the game in video feed 228 is a contest between the San Diego Chargers and the Oakland Raiders. There is a clock indicator 234 that indicates that this game is in the second quarter, and that there are nine minutes and 25 seconds remaining in the second quarter. When certain events occur, e.g., a game enters the final two minutes of a period or half, the clock indicator 234 can change colors to further indicate to a viewer that the end of a period is coming up. This may be important for certain types of events, and not as important for others, but is available as a graphical display for the clock indicator 234 within the scope of the present invention.

Further, there is a current score 236, showing that Oakland is winning the game, 14-10. There is also a “possession” indicator 238, which is shown as a different color or other graphical indicator, that shows that San Diego is currently in possession of the ball. For example, the light blue color of the possession indicator 238 indicates that San Diego is in possession of the ball.

Further, the possession indicator 238 can have a different size, position, or other graphical indicator to show the field position of the team in possession. For example, San Diego's possession indicator 238 shows that San Diego is currently at approximately midfield, because the possession indicator 238 in video cell 202 is approximately halfway across the possession indicator 238 graphics area. However, video cell 204, which is showing the Atlanta/New York Giants game, shows that Atlanta is currently on the Atlanta side of the field, since possession indicator 238 is of a different length and is less than halfway across the respective indicator 238 graphics area.

When certain game conditions occur, position indicator 238 may also change color as well as size. For example, when a team gets within twenty yards of the end zone on offense, they are considered in “the red zone” of the field. To indicate such a game condition, the position indicator 238 can turn red, which indicates to a viewer that a team is inside scoring range for either a touchdown or a field goal. When a team scores, the position indicator can flash or turn green, to indicate that the score of the game recently changed. Other indicators are possible, e.g., when a penalty is called, one or both of the position indicators 238 can turn yellow, when a turnover occurs, the recovering team's position indicators 238 can flash orange, etc.

For other types of video feeds, possession indicator 238 may provide other types of information. For example, in a hockey game, possession of the puck by a given team does not necessarily indicate an advantage in the game or an impending score. However, if one hockey team is on a power play, or has a two-person advantage, possession indicator 238 can indicate these condition by changing color, flashing, or other graphical indication to the viewer, such that the game condition is known by glancing at the mix channel 200 in an overview fashion, rather than paying attention to each video cell 202-216 in detail to determine the progress of each video feed. So, for example, if one hockey team is on a power play (one-person advantage), the possession indicator 238 may be green. If one hockey team has a two-person advantage, the possession indicator 238 may be red, or flashing green, to indicate a different game condition to the viewer.

The possession indicator 238, clock indicator 234, or team identifiers 230-232 can also change color, flash on and off, or present any number of visual clues to the viewer, to indicate what is going on within video cell 202. For example, as shown in video cell 206, Indianapolis is in possession of the ball and the possession indicator 238 is almost all the way over to the right, which means Indianapolis is threatening to score. The possession indicator 238 is colored red, and the background color of Baltimore's possession indicator 238 changes from a dark blue to a maroon. Further, in video cell 212, Green Bay's possession indicator 238 is bright green, indicating a recent score by Green Bay.

### Placement of Video Cells

The placement for each video cell 202-216 can depend on a wide variety of factors, such as Nielsen ratings for a given channel, whether a given channel is available on a specific viewer's programming package, viewer channel number (lowest to highest or highest to lowest), expected ratings of the video feed, or can be decided or changed based on programming that is present on one or more of the viewer channels available for the interactive mosaic channel.

For example, and not by way of limitation, a game between two division rivals, such as New England and Miami, may have an expected viewer rating higher than a game between two teams that are not doing well in a given season. As such, the New England/Miami game may be placed in video cell 202 rather than in video cell 206, or vice versa. Further, as video cell 202-216 information becomes static, e.g., a game ends, or, conversely, as video cell 202-216 information becomes more important, e.g., a game goes into overtime, placement or movement of the video feeds for the video cells 202-216 can be changed.

Other information may also appear in video cell 202-216, such as an indication that the video feed that is being presented in the associated video cell 202 is a “user favorite” channel, the video cell 202-216 may be presented in a different color or video texture to indicate that the video feed that is being presented in the associated video cell 202 is a channel that presents programming that adults may wish to block from their children's view or has closed-captioning available, etc. Many possibilities are available within the scope of the present invention to present various types of video information within video cell 202-206 for viewer selection and benefit. Further, if the video feed for a given channel has not started yet, e.g., a game has not started yet, a graphic may be displayed to indicate the nature of the upcoming video feed for that video cell 202-216.

### Text Box

Text box 218 contains textual information that is useful to the viewer, and this information can change depending on the viewer's selection of interactive services as described herein. For example, the text box 218 can contain a generic statement about the genre of the interactive mosaic channel 200, or statements directed to a selected video cell 202-216 or information related to a selected video cell 202-216 to describe to a user the meaning of the information presented in the video cell 202-216 or other information related to the video cell 202-216. The text box can also scroll to present additional information to the viewer that does not all fit within text box 218 at a given time.

There can also be default text associated with each interactive mosaic channel 200, and, depending on the capabilities of IRD 112, each time an interactive mosaic channel 200 is tuned to, a default descriptive text shall be displayed in the text box 218.

### Background Video

Background video 222 is typically a backdrop for the interactive mosaic channel 200. The background video 222 can be related to the genre of the interactive mosaic channel 222; for example, in a news environment, the background video 208 can be related to a top news story, the stock market exchange building, a prominent government building, etc. The background video 222 can be changed or can be a dynamic video depending on the desires of the editorial staff or viewer preferences. Further, the background video 222 can be a logo or other indicator of the source of the interactive mosaic channel 200, such as DIRECTV.

### Dynamic Ticker

The dynamic ticker 224 can be used to provide real-time updates to the genre of the interactive mosaic channel 200. For example, in a sports environment, the dynamic ticker 224 can provide updated scores or breaking news, or act as an alert system as described herein. The dynamic ticker 210 can also be used to present other information, such as statistics, closed captioning information, or other information, that can be related to the genre or to other issues. The dynamic ticker 224 can also be updated with new information at a different rate than that of the video cells 202-216, because the source of information that is used to create dynamic ticker 224 comes from a different source than the information that is presented in video cells 202-216.

### Viewer Interaction

By selecting a given video cell 202-216, the viewer is selecting a specific characteristic associated with that given video cell 202-216, or associated video feed 228 used to generate that video cell 202-216. In most instances, when the viewer selects a given video cell 202-216 via cursor 220, the audio portion associated with the selected video cell 202-216 will be presented to the viewer, rather than a generic audio portion associated with interactive mosaic channel 200. Further, selection of a given video cell 202-216 with cursor 220 may also select a closed captioning data stream associated with the selected video cell 202-216, depending on the availability of such a data stream and/or other settings that a viewer has selected. Cursor 220 can be moved to any of the video cells 202-216, and, optionally, can be moved to select text box 218 or ticker 224.

When cursor 220 is moved to a given video cell 202-216, or to text box 218 or ticker 224, text box 218 also may undergo a change in information. Typically, when the video cell 202-216 is selected by the viewer, indicated by the presence of cursor 220, text box 218 will present the information in the Advanced Program Guide (APG) that is associated with the viewer channel (indicated by channel indicator 226) selected by cursor 220. The APG typically includes information on the program or “show” that is currently being presented by the viewer channel shown in video cell 202-216, as well as the time that show is being aired and the next show to be aired on that viewer channel. Other information, either in the APG or external to the APG, can also be displayed in the text box 218 when the cursor is moved to a given video cell 202-216. The text box 218 can also remain static if desired.

As such, the viewer can “interact” with the interactive mosaic channel 200 and decide which audio track to listen to, find out a plot line of each of the shows being presented in the various video cells 202-216, or find out what is going to be aired next in the various viewer channels being presented in video cells 202-216, while variously viewing the video presentations in the video cells 202. If a specific video cell 202-216 presents video information that is of interest to a viewer, then the viewer can move cursor 500, via a remote control command, to a given video cell 202.

If the viewer decides that the selected video cell 202 is of enough interest, the viewer can then directly tune to the selected video cell 202, i.e., tune directly to that viewer channel that is providing the video and audio used to create video cell 202, by pressing a single button on the remote control (typically the “select” button on a DIRECTV remote control). This will tune the IRD 112 or monitor 114 to that viewer channel, which will then be presented fill-screen to the viewer as in a normal television monitor 114 viewing format.

### Default Conditions

When a viewer arrives at a given interactive mosaic channel 200, the position of cursor 220 may default to the first video cell 202, any given video cell 202-216, or not be present at all. The viewer may have to press a button on the remote control to activate the cursor 220. Typically, a viewer moves the cursor 220 by using the up/down/left/right keys on a remote control associated with the IRD 112, but other methods can be used without departing from the scope of the present invention. Further, if IRE 112 is not enabled for any or enough interactive services, the cursor 220 functions may be disabled, either entirely or partially, depending on the capabilities of IRM 112.

There can also be the ability to record interactive mosaic channel 200 which will allow a viewer to record what would be several viewer channels as a single viewer channel, i.e., the recorded interactive mosaic channel 200. However, a recorded version of interactive mosaic channel 200 may act differently than a live-feed interactive mosaic channel 200, because the cursor 220 functions may no longer be consistent with a recorded version of that video information. For example, selection of a video cell 202, in a live-feed version, would tune the RD 112 to the channel number associated with that video cell 202. When it is a recorded version, selection of that video cell would not tune the IRD 112 to the channel number, but would likely present that recorded video information in a full-monitor 114 format, with possible degradation of picture quality. The ability to record interactive mosaic channel 200 may also be selectively disabled if desired.

### Changes in Interactive Mosaic Channel Display

Some of the interactive mosaic channels 200 may, because of the genre selected for that interactive mosaic channel 200 or for other reasons, may need to have the video cells 202-216 changed from one viewer channel to another, or to have video cells 202-216 added or deleted from the presentation of the interactive mosaic channel 200 on monitor 114. As such, there must be a capability to change the presentation of any given interactive mosaic channel 200. The changes may be of a time-sensitive nature, such as changes in news or sporting events, or a seasonal change, such as additional viewer channels carrying an event such as the NCAA Basketball Tournament, and thus, would be seasonally included in an interactive mosaic channel 200 presentation, or of a programming nature, where a viewer adds or deletes a viewer channel to their programming package and thus access to such a viewer channel is selectively allowed or denied. If such a viewer channel is being used to create a given interactive mosaic channel 200, then the interactive mosaic channel 200 must have the capability of adding that video feed for presentation on the monitor.

For example, in a sports genre interactive mosaic channel 200, it is typically known when a sporting event will start and which viewer channel the event will be carried on. So, interactive mosaic channel 200 can schedule the change to the video feed for that viewer channel as being shown on a video cell 202, or change away from a viewer channel that is no longer carrying a sporting event, based on a schedule or other set time-frame events.

When such changes take place, the service provider (which can be DIRECTV, or some other service provider) can program the interactive mosaic channel 200 to change the video presentation on channel 200. This can be done in a variety of ways, either by selectively blacking out the video cells 202-216, presenting a graphic on the video feed during the changes made to the video cells 202-216, or other methods, presented to the viewer in such a way that the video feeds 228 used to create video cells 202-216 are not visible. It may or may not be desirable to present information on the dynamic ticker 210 that the viewer needs to wait during the change in programming. Once the interactive mosaic channel 200 programming is completed, the service provider would then send the video information that shows the new configuration of video cells 202-216, new text box 204 information, etc. Other methods of performing the change in video presentation of viewer channels are also possible within the scope of the present invention.

The service provider, and the viewer, have the ability to black out or disable viewer channels, and, as such, have the ability to black out or disable not only entire interactive mosaic channels 200, but the individual video feeds that are associated with video cells 202 that are presented within an interactive mosaic channel 200. Further, users may have the ability to create their own interactive mosaic channel 200, depending on the equipment capabilities of IRD 112, monitor 114, or other equipment that a specific viewer may have access to.

### Interactive Features

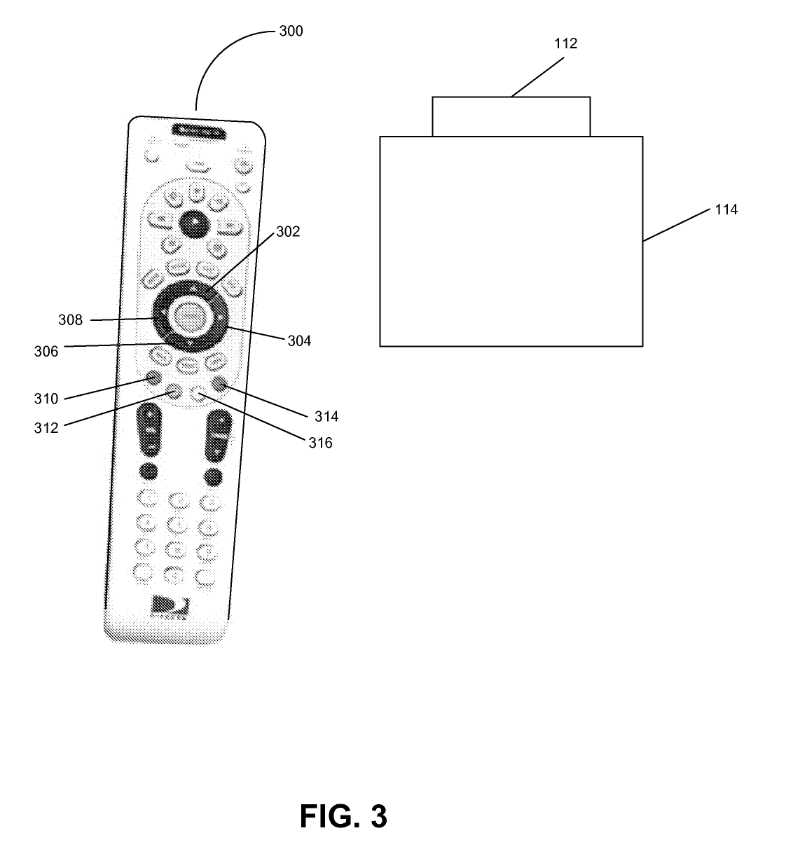

FIG. 3 illustrates a remote control used in the present invention.

Typically, IRD 112 and monitor 114 are controlled by a remote control device 300, which allows viewers a convenient way to control audio volume, channel selection, and other features and display characteristics from a distance away from the IRD 112 and/or monitor 114.

Each video cell 202A-F has an associated channel ID box 212, and one of the video cells, cell 202D, has a cursor 214 surrounding that specific video cell 202 and, optionally, channel ID box 212. The cursor 214 indicates that the specific video cell 202 and channel ID 212 has been selected by the viewer. The cursor 214 is typically controlled by buttons 302-308, but can be controlled by other buttons on the remote control 300 if desired.

By selecting a given video cell 202A-F, the viewer is selecting a specific characteristic associated with that given video cell 202A-F, or associated video feed used to generate that video cell 202A-F. In most instances, when the viewer selects a given video cell 202, the audio portion associated with the selected video cell 202 will be presented to the viewer, rather than the audio portion associated with the barker cell 206 or a generic audio track that is associated with interactive mosaic channel 200. Further, selection of a given video cell 202A-F with cursor 214 may also select a closed captioning data stream associated with the selected video cell 202, depending on the availability of such a data stream and/or other settings that a viewer has selected. Cursor 214 can be moved to any of the video cells 202A-F, and, optionally, can be moved to select text box 204 or control bar 210.

When cursor 214 is moved to a given video cell 202A-F via buttons 302-308, text box 204 also may undergo a change in information. Typically, when the video cell 202A-F is selected by the viewer, indicated by the presence of cursor 214, text box 204 will present the information in the Advanced Program Guide (APG) that is associated with the viewer channel selected by cursor 214. The APG typically includes information on the program or “show” that is currently being presented by the viewer channel shown in video cell 202A-F, as well as the time that show is being aired and the next show to be aired on that viewer channel. Other information, either in the APG or external to the APG, can also be displayed in the text box 204 when the cursor is moved to a given video cell 202A-F.

As such, the viewer can “interact” with the interactive mosaic channel 200 and decide which audio track to listen to, find out a plot line of each of the shows being presented in the various video cells 202, find out what is going to be aired next in the various viewer channels being presented in video cells 202, or listen to generic audio from the barker cell 206 or associated with the interactive mosaic channel 200 itself while variously viewing the video presentations in the video cells 202. If a specific video cell 202 presents video information that is of interest to a viewer, then the viewer can move cursor 214, via a remote control command, to a given video cell 202, and listen to the audio associated with that video cell 202 and find out more about that viewer channel in text box 204.

If the viewer decides that the selected video cell 202 is of enough interest, the viewer can then directly tune to the selected video cell 202, i.e., tune directly to that viewer channel that is providing the video and audio used to create video cell 202, by pressing a single button on the remote control 300 (typically the “select” button on a DIRECTV remote control). This will tune the IRD 112 or monitor 114 to that viewer channel, which will then be presented full-screen to the viewer as in a normal television monitor 114 viewing format.

The barker cell 206, since it typically contains audio and video information that is not located on any viewer channel other than the interactive mosaic channel 200, cannot typically be selected for full screen viewing by the viewer on monitor 114. However, the barker cell 206 can be selected for full monitor 114 viewing, or at least enough of the monitor 114 to allow for changes in the video cells 202 as described below, to allow for changes in the interactive mosaic channel 200 and in the control bar 210 in near-real-time.

### Control Bar

The Control Bar 210 (also called the Attract Icon or the Attract Icon Bar) The control bar 210 allows for instant, on-screen access to several data sources that allow the viewer to access data related to that being shown in the video cells 202A-F as well as other viewer channels available within system 100. Those IRDs 112 that have interactive capabilities have special buttons that correspond to the icons that appear on the control bar 210. Each icon/button directs the viewer to a different screen, such as special events, or, in the case of the present invention, data related to real-time or near-real-time viewership of channels within system 100. Each screen can have sub-screens that further allow related data to be viewed or otherwise analyzed by the viewer.

For example, and not by way of limitation, one of the remote control 300 buttons, e.g., the “red” button 234, indicated by text and/or graphics on control bar 210, may take a viewer to the “What's Hot” page, where viewers can review data related to viewership of shows currently being aired within system 100.

Similarly, a “special” page can be accessed by pressing a different button on the remote control 300, e.g., the “green” button 312, or the blue button 314 or yellow button 316, where viewers can view a channel or other data page. The special page can be reprogrammed by the system provider or the viewer based on time, or, in the case of interactive mosaic channel 200, can be done by genre. For example, and not by way of limitation, the special page can be assigned to the NCAA bracket for a “Sports” mosaic channel 200, and, if the viewer changes to a “News” mosaic channel 200, the special page can be a breaking news channel or news recap video loop that is provided by the system provider. There can be more than one special “page” that is accessible from the buttons 310-316, or other buttons on the remote control 300, if desired.

### Chip Display on Screen

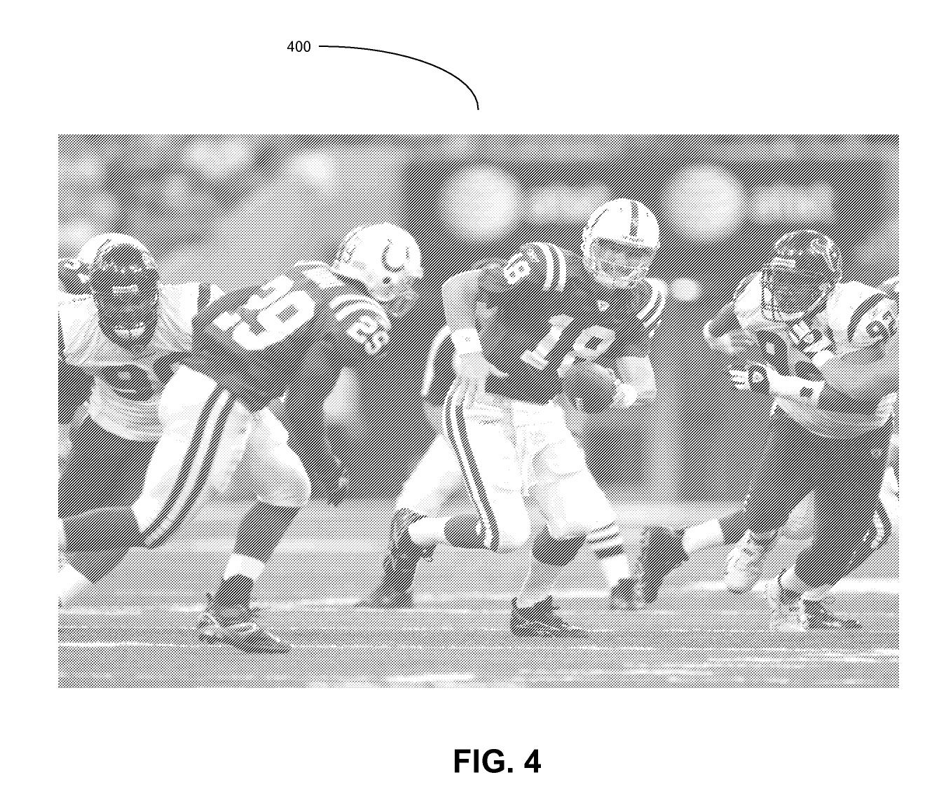

FIG. 4 illustrates a viewer channel shown on a monitor in accordance with the present invention.

Screen 400 is typically displayed on monitor 114, and is a viewer channel. Screen 400 can be selected from interactive mosaic channel 200, or can be selected from any other channel available to IRD 112.

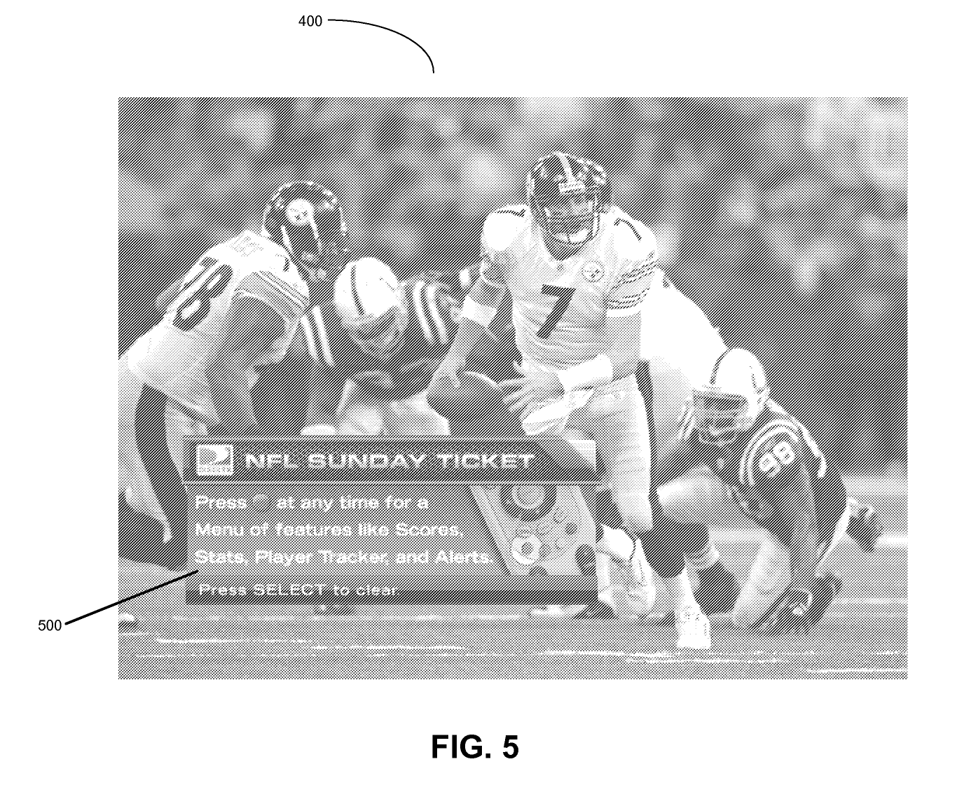

FIG. 5 illustrates an informational overlay in accordance with the present invention.

Screen 400 can also have an informational overlay 500 that selectively appears when IRE 112 is enabled to receive a specific programming package or other feature within system 100. For example, and not by way of limitation, when a user is watching screen 400, and the user's IRD 112 is enabled to receive a specific programming package of National Football League™ games, informational overlay 500 can appear when that package is available and the interactive aspects of that package is available to the user. The user is not required to be watching a specific game or channel to have informational overlay 500 appear; so, for example, the user can be watching a channel not associated with the programming package, however, when the interactive features of the programming package are available to the user, the informational overlay 500 is selectively displayed.

Informational overlay 500, also called an overlay data graphic, overlay video, or overlay video screen herein, can comprise video information, audio information, data, statistics, and/or any other information that may be of interest to the viewer. Further, the data, video, and other items that are displayed in information overlay 500 can come from different sources and be combined in a multiplicity of ways into a single informational overlay 500 if desired.

Informational overlay 500 can be removed from the screen by selecting a designated button 302 on remote control 300. Further, depending on IRD 112 programming and user desires, informational overlay 500 can be prevented from being displayed on certain channels. For example, and not by way of limitation, if IRD 112 is tuned to a specific channel such as a children's programming channel, or is receiving a pay-per-view event, IRD 112 or user interaction with IRD 112 can prevent informational overlay 500 from being displayed on monitor 114.

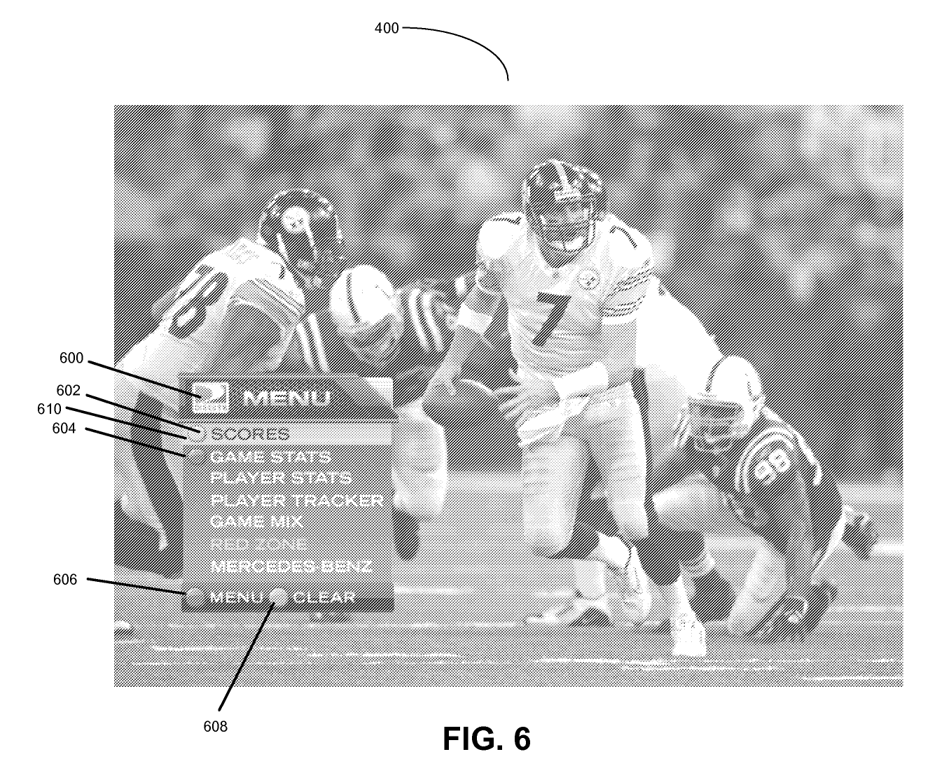

FIG. 6 illustrates a menu associated with the informational overlay of FIG. 5.

When informational overlay 500 is selected, e.g., when a specific button 310-316 or other button on remote control 300 is pressed by the user, menu 600 is displayed on monitor 114 overlaid on screen 400. Menu 600 comprises several selections 602-608, which allow the user to select from a variety of different items. Menu 600 displays the functions that buttons 310-316 and/or other buttons on remote control 300 will execute while menu 600 is active on monitor 114. For example, and not by way of limitation, selection 602 is selectable by pressing button 316, which will activate a “scores” feature of the present invention. Other selections 604-608 allow the user to select other functions as desired.

A cursor 610 allows user to access additional functions when buttons 310-316 are already assigned to other functions, and button 302 or other buttons on remote control 300 can be used to select these additional functions, without departing from the scope of the present invention. For example, and not by way of limitation, cursor 610 can be used to select additional channels and/or advertisement spots that would otherwise require channel selection or other specialized knowledge of which channel the programming is being presented on by IRD 112. Further, some programming may only be available through the programming package that activates and comprises menu 600.

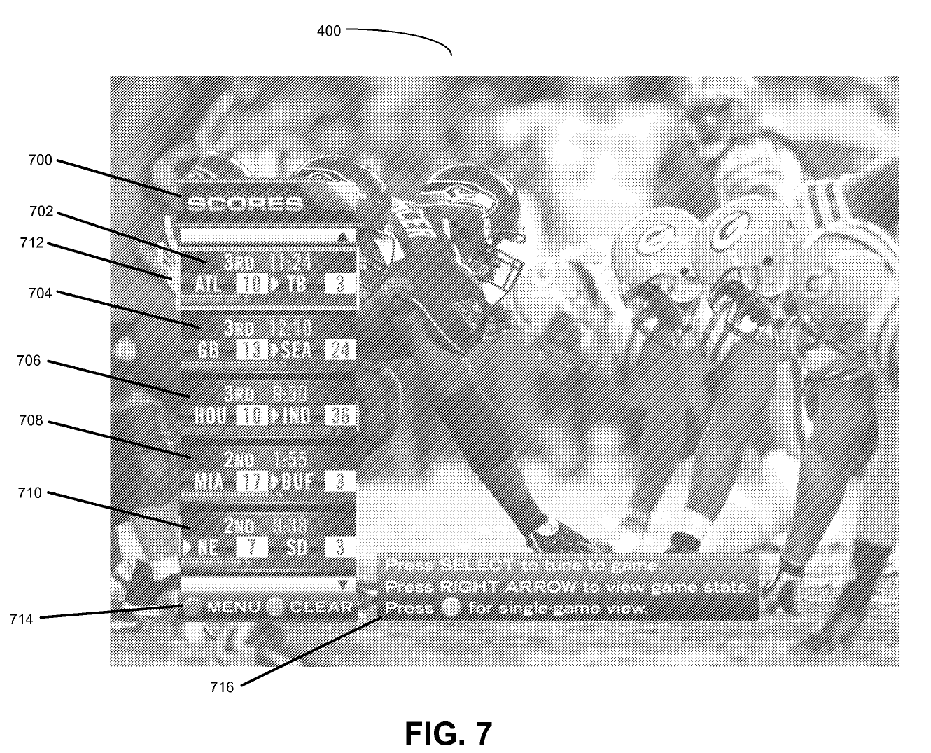

FIG. 7 illustrates a score chip in accordance with the present invention.

Once selection 602 is chosen by the user, either via cursor 610 or by pressing button 316 or other button associated with selection 602, chip 700 can be displayed. Chip 700 comprises a plurality of data areas 702-710, which display data related to the programming package. As shown in FIG. 7, this data is the score of currently contested NFL games, with indicators and other items shown as described with respect to FIG. 2, so that the user can see the progress of each contest, who is in possession of the ball, where the teams are on the field, etc. Further, a cursor 712 allows the user to scroll through the data areas 702-710, such that a data area can be selected if desired, or to scroll down to see additional data areas 702-710 that cannot fit within chip 700.

Area 714 shows the user that buttons 310-316 may have different functions when chip 700 is displayed, and area 716 describes how to use the cursor 712 and other buttons on remote control 300, and how functions of buttons on remote control 300 may change once chip 700 is displayed on monitor 114.

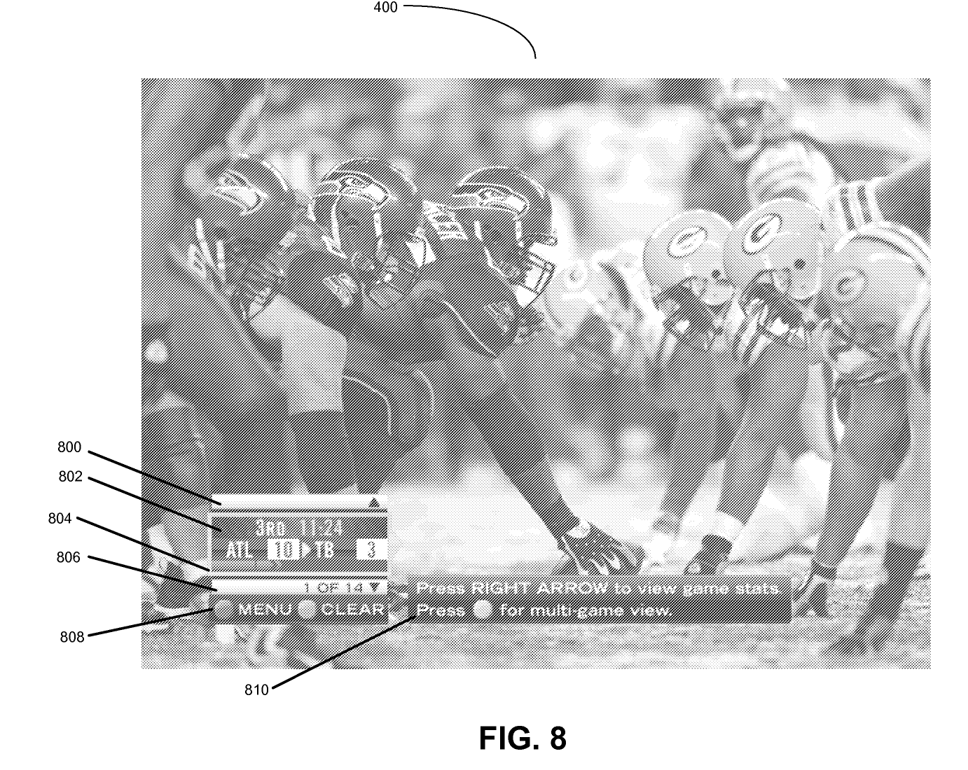

FIG. 8 illustrates a single game score chip in accordance with the present invention.

Once selection 602 is chosen by the user, either via cursor 610 or by pressing button 316 or other button associated with selection 602, chip 800 can also be displayed. Further, chip 800 can be displayed if a button 310-316 or other button on remote control 300 is selected by the user, for example, in response to the chip 700 instruction box 716 shown in FIG. 7.

Chip 800 comprises a single data area 802, which displays data related to the programming package. As shown in FIG. 8, this data is the score of a currently contested NFL game, with indicators and other items shown as described with respect to FIG. 2, so that the user can see the progress of the contest, who is in possession of the ball, where the teams are on the field, etc. Further, a cursor 804 allows the user to scroll through the data areas available for display in data area 802, such that a data area can be selected if desired, or to scroll down to see additional data areas that cannot fit within chip 800.

Area 806 shows the user that there are a number of data areas to be selected from using cursor 802, and area 808 indicates that buttons 310-316 may have different functions when chip 800 is displayed with respect to chip 700, or, for that matter, different functions that are assigned only when chip 800 is displayed with respect to other functions available within system 100 for buttons 310-316. Area 810 describes how to use the cursor 802 and other buttons on remote control 300, and how functions of buttons on remote control 300 may change once chip 800 is displayed on monitor 114.

Further, when chip 800 is turned off by selecting the appropriate button on remote control 300, when chip 800 is re-activated by the user, the data area 802 that was previously selected by the user can be displayed, or, if desired, a default data area 802 can be displayed. Similarly, chip 700 can also be programmed to display data areas 702-710 as defaults or chip 700 can display the last few data areas displayed to the user.

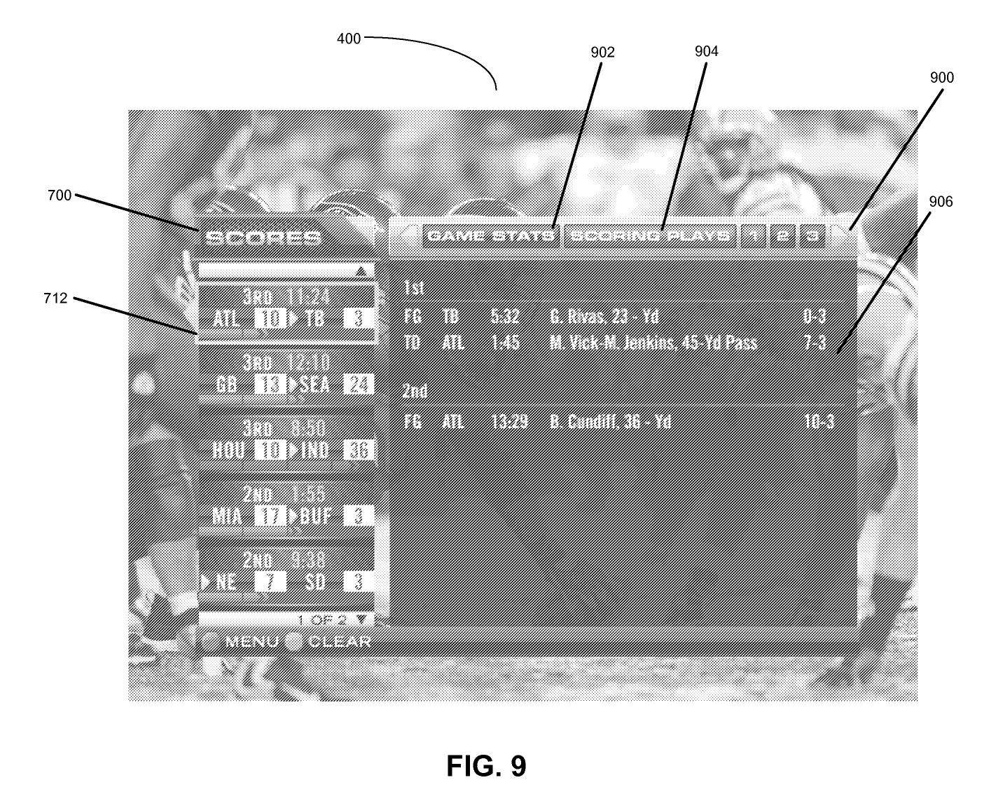

FIG. 9 illustrates a scoring summary chip in accordance with the present invention.

From either chip 700 or chip 800, or, if desired, directly from screen 400, the user can select a button from remote control 300 to display chip 900, which can provide additional details about the data shown in chips 700 and/or 800, respectively. Chip 900 content can be changed depending on where chip 900 is accessed from, e.g., if chip 900 is accessed from chip 700, chip 900 can have a first content of data; if chip 900 is accessed from chip 800, chip 900 can have a second, or different, content of data. The data shown in chips 700, 800, and 900 can vary based on the programming package that is accessible by IRD 112, or by other ways, without departing from the scope of the present invention.

Chip 900 comprises categories 902 and 904, and data area 906. Categories 902 and 904 allow the user to display different types of data, e.g., game statistics, scoring plays within a game, etc. So, for example, when cursor 712 is on a data area within chip 700, and the proper button (e.g., button 304) is pressed by the user, chip 900 will be displayed or overlaid on screen 400 and the user can then use other buttons on remote control 300 to select category 902 or category 904. As the user selects one of the categories 902 or 904, the data area 906 changes to indicate the data associated with the various categories 902 and 904.

Other uses for chips 700, 800, and 900 can be envisioned within the scope of the present invention. Other sporting genres, e.g., baseball, basketball, hockey, specialty sporting events such as the Olympics and the annual NCAA basketball tournament, as well as other items such as news events or community or world-wide events can be envisioned as being displayed within chips 700, 800, and 900 as desired.

System 100 can be programmed by the user to have a default chip, whether it be chip 700, 800, or 900, be presented when the appropriate button is pressed on remote control 300.

### Conclusion

The present invention comprises an interactive system and method for displaying a chip (or overlay video) on a video monitor. A system in accordance with the present invention comprises a first video stream presenting at least video information, the first video stream comprising a viewer channel, and an overlay video, displayed simultaneously with the first video stream, wherein the overlay video has a universal functionality with respect to at least one of a plurality of other video streams.

Such a system further optionally comprises the overlay video displaying different analogous data elements with respect to each of the other video streams, the interactive system changing display of the overlay video from an identifying display of a first other video stream to an identifying display of a second other video stream, the overlay video comprising a menu screen, the menu screen comprising instructions to access additional overlay video screens, at least one of the additional overlay video screens comprising a plurality of data areas, at least one of the additional overlay video screens comprising a single data area that is scrolled through via the remote control, a nested video screen being accessed through the plurality of data areas, a nested video screen being accessed through the single data area, and the nested video screen being only accessible through the single data area.

Another system in accordance with the present invention displays a plurality of individual video feeds at a given time, and comprises a broadcast delivery system, comprising a transmitter and a receiver, a monitor, coupled to the receiver, for displaying a first video stream presenting at least video information, the first video stream comprising a viewer channel, and an overlay video, displayed simultaneously with the first video stream, wherein the overlay video has a universal functionality with respect to at least one of a plurality of other video streams.

Such a system further optionally comprises the broadcast delivery system being a satellite television delivery system, the overlay video displaying different analogous data elements with respect to each of the other video streams, a menu screen comprising instructions to access additional overlay video screens, at least one of the additional overlay video screens comprising a plurality of data areas, and the at least one overlay video screen being only accessible through the plurality of data areas.

Another system for displaying an overlay video and at least one other video feed at a given time in accordance with the present invention comprises means for transmitting the overlay video and the at least one other video feed, means for displaying a first video feed presenting at least video information, and means for displaying the overlay video simultaneously with the first video stream, wherein the overlay video has a universal functionality with respect to at least one of a plurality of other video streams.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description.

What is claimed is:

1. An interactive system displayed on a video monitor, comprising
a first video stream presenting at least video information, the first video stream comprising a viewer channel; and
an overlay video, displayed simultaneously with the first video stream, wherein the overlay video has a universal functionality with respect to a plurality of other video streams.

2. The interactive system of claim 1, wherein the overlay video displays different analogous data elements with respect to each of the other video streams.

3. The interactive system of claim 2, wherein the interactive system changes display of the overlay video from an identifying display of a first other video stream to an identifying display of a second other video stream.

4. The interactive system of claim 3, wherein the overlay video comprises a menu screen.

5. The interactive system of claim 4, wherein the menu screen comprises instructions to access additional overlay video screens.

6. The interactive system of claim 5, wherein at least one of the additional overlay video screens comprises a plurality of data areas.

7. The interactive system of claim 5, wherein at least one of the additional overlay video screens comprises a single data area that is scrolled through via the remote control.

8. The interactive system of claim 6, wherein a video screen is accessed through the plurality of data areas.

9. The interactive system of claim 7, wherein a video screen is accessed through the single data area.

10. The interactive system of claim 9, wherein the video screen is only accessible through the single data area.

11. A system for displaying a plurality of individual video feeds at a given time, comprising:
a broadcast delivery system, comprising a transmitter and a receiver;
a monitor, coupled to the receiver, for displaying a first video stream presenting at least video information, the first video stream comprising a viewer channel; and
an overlay data graphic, displayed simultaneously with the first video stream, wherein the overlay data graphic has a universal functionality with respect to a plurality of other video streams.

12. The system of claim 11, wherein the broadcast delivery system is a satellite television delivery system.

13. The system of claim 12, wherein the overlay data graphic displays different analogous data elements with respect to each of the other video streams.

14. The system of claim 13, wherein the overlay data graphic comprises a menu screen that comprises instructions to access additional overlay video screens.

15. The system of claim 14, wherein at least one of the additional overlay video screens comprises a plurality of data areas.

16. The system of claim 15, wherein the at least one additional overlay video screens is only accessible through the plurality of data areas.

17. A system for displaying an overlay video and at least one other video feed at a given time, comprising:
means for transmitting the overlay video and the at least one other video feed;
means for displaying a first video feed presenting at least video information; and
means for displaying the overlay video simultaneously with the first video stream, wherein the overlay video has a universal functionality with respect to a plurality of other video streams.
